(19) United States
(12) Patent Application Publication
(10) Pub. No.: US 2011/0064038 A1
(43) Pub. Date: Mar. 17, 2011

(54) Method and Apparatus for Handling Information of Cyclic Prefix Length in Wireless Communication System

(76) Inventor: Richard Lee-Chee Kuo, Taipei City (TW)

(21) Appl. No.: 12/884,219

(22) Filed: Sep. 17, 2010

Related U.S. Application Data
(60) Provisional application No. 61/243,162, filed on Sep. 17, 2009.

(51) Int. Cl. H04W 72/04

(52) U.S. Cl. 370/329; 455/509

(57) ABSTRACT

A method for handling information of cyclic prefix length in a wireless communication system is disclosed. The wireless communication system supports Carrier Aggregation, which enables a user equipment (UE) of the wireless communication system to perform transmission and/or reception through multiple carriers. The method includes steps of configuring at least one downlink carrier to the UE via an RRC message, and delivering the information of cyclic prefix length of the at least one downlink carrier to the UE via a dedicated signaling.

### CROSS REFERENCE TO RELATED APPLICATIONS

This application claims the benefit of U.S. Provisional Application No. 61/243,162, filed on Sep. 17, 2009 and entitled “Method and apparatus for Cyclic Prefix and Reference Signals supporting Carrier Aggregation and MCCH Configuration in a wireless communication system”, the contents of which are incorporated herein by reference.

### BACKGROUND OF THE INVENTION

1. Field of the Invention

The present invention relates to a method and apparatus for handling information of cyclic prefix (CP) length, and more particularly, to a method and apparatus capable of reducing time required for a user equipment (UE) to acquire information of downlink CP length, to effectively enhance data transmission efficiency.

2. Description of the Prior Art

Long Term Evolution wireless communication system (LTE system), an advanced high-speed wireless communication system established upon the 3G mobile telecommunication system, supports only packet-switched transmission, and tends to implement both Medium Access Control (MAC) layer and Radio Link Control (RLC) layer in one single communication site, such as in base stations (Node Bs) alone rather than in Node Bs and RNC (Radio Network Controller) respectively, so that the system structure becomes simple.

Besides, a physical layer of the LTE system operates based on Orthogonal Frequency Division Multiple Access (OFDM) with a cyclic prefix (CP) in the downlink and a Single Carrier Frequency Division Multiple Access (SC-FDMA) with a CP in the uplink. A CP is added at the beginning of each OFDM symbol to create a guard period for eliminating inter-symbol interference (ISI) caused by multipath propagation. In the prior art, there are two types of CP, which are normal CP and extended CP with different lengths. For unicast transmission, the normal CP length is 0.5 μs and the extended CP length is 17 μs. In such a situation, in order to ensure the physical layer can correctly encode and decode OFDM symbols, a UE needs to know the uplink CP length and the downlink CP length. Therefore, during initial cell search, the UE detects the downlink CP length from synchronization channels, and acquires the uplink CP length from the system information delivered by a network terminal.

On the other hand, in order to meet future requirements of all kinds of communication services, the 3rd Generation Partnership Project (3GPP) has started to work out a next generation of the LTE system: the LTE Advanced (LTE-A) system. Carrier aggregation (CA), where two or more component carriers are aggregated, is introduced into the LTE-A system in order to support wider transmission bandwidths, e.g. up to 100 MHz and for spectrum aggregation. In the LTE-A system, a user equipment (UE) may use multiple component carriers to establish multiple links with a network terminal for simultaneously receiving and transmitting on multiple component carriers, so as to enhance transmission bandwidth and spectrum aggregation.

With CA being introduced, after the UE establishes a Radio Resource Control (RRC) connection with the network terminal via a cell including an uplink subcarrier and a downlink subcarrier, the network terminal can deliver an RRC message configuring multiple subcarriers to the UE for high speed data transmission. In such a situation, since each downlink subcarrier for unicast transmission has a CP, according to the prior art, the UE needs to detect the synchronization channels of each downlink subcarrier, to know all CP lengths, so as to correctly decode received OFDM symbols. In other words, after a plurality of downlink carriers are configured to the UE, the UE takes time to detect the synchronization channels of each subcarrier, and thus it delays the following data transmission.

### SUMMARY OF THE INVENTION

It is therefore an objective of the present invention to provide a method and apparatus for handling CP length information in a wireless communication system.

The present invention discloses a method for handling information of cyclic prefix (CP) length in a network terminal of a wireless communication system. The wireless communication system supports Carrier Aggregation, which enables a user equipment (UE) of the wireless communication system to perform transmission and/or reception through multiple carriers. The method includes steps of configuring at least one downlink carrier to the UE via a Radio Resource Control (RRC) message, and delivering the information of CP length of the at least one downlink carrier to the UE via a dedicated signaling.

The present invention further discloses a communication device for handling information of cyclic prefix (CP) length in a network terminal of a wireless communication system. The wireless communication system supports Carrier Aggregation, which enables a user equipment (UE) of the wireless communication system to perform transmission and/or reception through multiple carriers. The communication device includes a processor for executing a program, and a memory coupled to the processor for storing the program. The program includes steps of configuring at least one downlink carrier to the UE via a Radio Resource Control (RRC) message, and delivering the information of CP length of the at least one downlink carrier to the UE via a dedicated signaling.

The present invention further discloses a method for handling information of cyclic prefix (CP) length in a user equipment (UE) of a wireless communication system. The wireless communication system supports Carrier Aggregation, which enables the UE to perform transmission and/or reception through multiple carriers. The method includes steps of receiving a Radio Resource Control (RRC) message delivered by a network terminal of the wireless communication system, the RRC message configuring at least one downlink carrier to the UE, and receiving a dedicated signaling delivered by the network terminal, to acquire information of CP length of the at least one downlink carrier.

The present invention further discloses a communication device for handling information of cyclic prefix (CP) length in a user equipment (UE) of a wireless communication system. The wireless communication system supporting Carrier Aggregation, which enables the UE to perform transmission and/or reception through multiple carriers. The communication device includes a processor for executing a program, and a memory coupled to the processor for storing the program. The program comprises includes steps of receiving a Radio Resource Control (RRC) message delivered by a network terminal of the wireless communication system, the RRC message configuring at least one downlink carrier to the UE, and receiving a dedicated signaling delivered by the network terminal, to acquire information of CP length of the at least one downlink carrier.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system.

FIG. 2 is a function block diagram of a wireless communications device.

FIG. 3 is a diagram of a program of FIG. 2.

FIG. 4 is a flowchart of a process according to an embodiment of the present invention.

FIG. 5 is a flowchart of another process according to an embodiment of the present invention.

### DETAILED DESCRIPTION

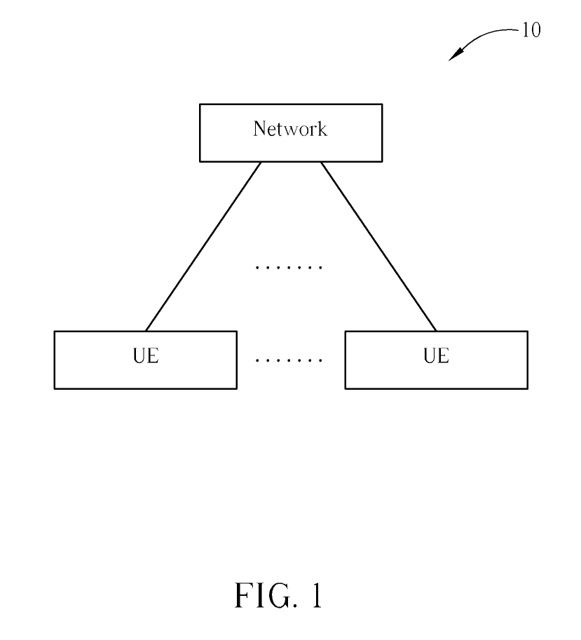

Please refer to FIG. 1, which illustrates a schematic diagram of a wireless communication system 10. The wireless communication system 10 is preferably an LTE advanced (LTE-A) system, and is briefly composed of a network and a plurality of user equipments (UEs). In FIG. 1, the network and the UEs are simply utilized for illustrating the structure of the wireless communication system 10. Practically, the network may comprise a plurality of base stations (Node Bs), radio network controllers and so on according to actual demands, and the UEs can be devices such as mobile phones, computer systems, etc.

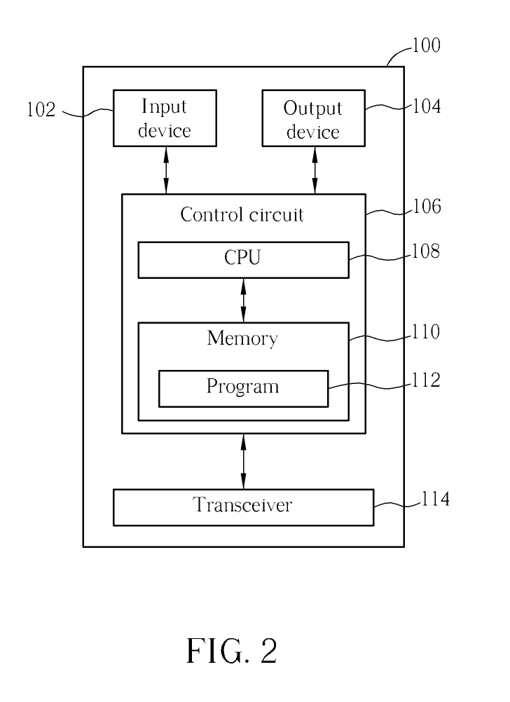

Please refer to FIG. 2, which is a functional block diagram of a communication device 100 in a wireless communication system. The communication device 100 can be utilized for realizing the UEs in FIG. 1. For the sake of brevity, FIG. 2 only shows an input device 102, an output device 104, a control circuit 106, a central processing unit (CPU) 108, a memory 110, a program 112, and a transceiver 114 of the communication device 100. In the communication device 100, the control circuit 106 executes the program 112 in the memory 110 through the CPU 108, thereby controlling an operation of the communication device 100. The communication device 100 can receive signals input by a user through the input device 102, such as a keyboard, and can output images and sounds through the output device 104, such as a monitor or speakers. The transceiver 114 is used to receive and transmit wireless signals, deliver received signals to the control circuit 106, and output signals generated by the control circuit 106 wirelessly. From a perspective of a communication protocol framework, the transceiver 114 can be seen as a portion of Layer 1, and the control circuit 106 can be utilized to realize functions of Layer 2 and Layer 3.

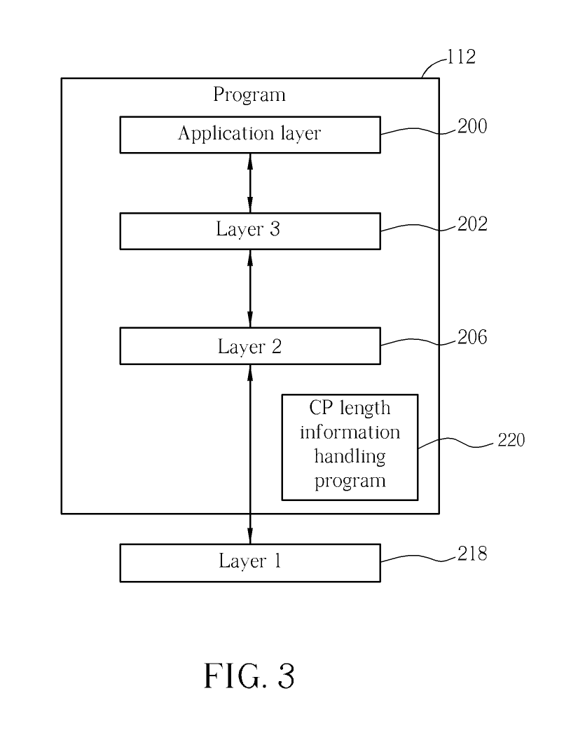

Please continue to refer to FIG. 3. FIG. 3 is a diagram of the program 112 shown in FIG. 2. The program 112 includes an application layer 200, a Layer 3 202, and a Layer 2 206, and is coupled to a Layer 1 218. The Layer 3 202 performs radio resource control. The Layer 2 206 comprises a Radio Link Control (RLC) layer and a Medium Access Control (MAC) layer, and performs link control. The Layer 1 218 performs physical connections.

In LTE-A system, the Layer 1 218 and the Layer 2 206 may support a Carrier Aggregation (CA) technology, which enables the UE to perform transmission or reception through multiple carriers configured by the upper layer. In addition, the Layer 1 218 operates based on Orthogonal Frequency Division Multiple Access (OFDM) with a cyclic prefix (CP) in the downlink. There are two types of CP, which are normal CP and extended CP with lengths of 0.5 μs and 17 μs, respectively. In such a situation, in order to ensure the physical layer can correctly decode received symbols, a UE needs to know the downlink CP length. Therefore, the embodiment of the present invention provides a CP length information handling program 220 in the program 112, in order to reduce the time required for the UE to acquire information of downlink CP length.

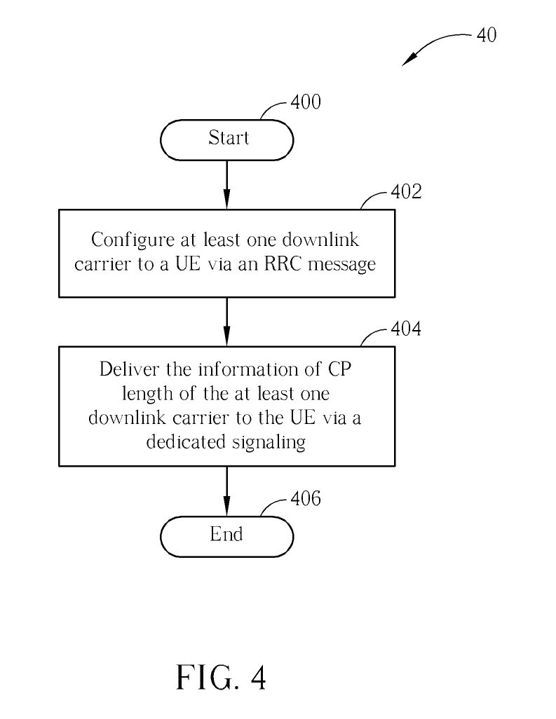

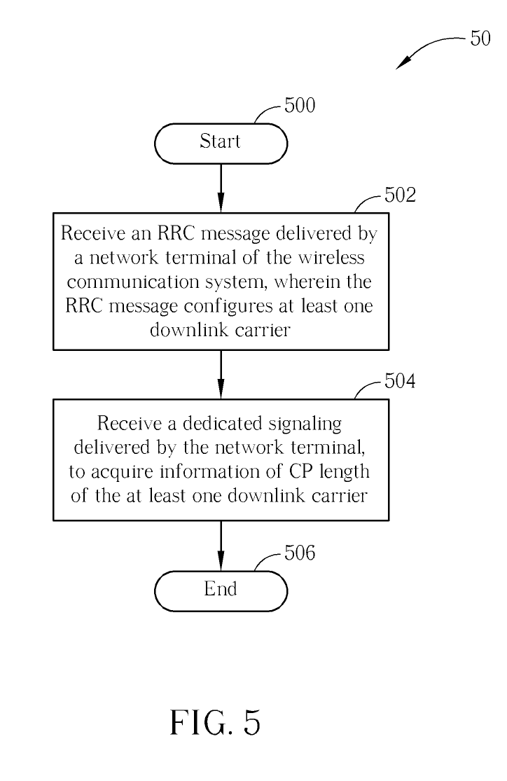

Please refer to FIG. 4 and FIG. 5 at the same time. FIG. 4 and FIG. 5 are schematic diagrams of processes 40 and 50 according to embodiments of the present invention, respectively. The process 40 is utilized in a network terminal of the wireless communication system 10, and the process 50 is utilized in a UE of the wireless communication system 10. The processes 40 and 50 cooperate to handle CP length information, and can be complied into the CP length information handling program 220 of the network terminal and the UE, respectively. As shown in FIG. 4, the process 40 includes the following steps:

Step 400: Start.

Step 402: Configure at least one downlink carrier to a UE via a Radio Resource Control (RRC) message.

Step 404: Deliver the information of CP length of the at least one downlink carrier to the UE via a dedicated signaling.

Step 406: End.

Then, the process 50 includes the following steps as shown in FIG. 5:

Step 500: Start.

Step 502: Receive an RRC message delivered by a network terminal of the wireless communication system, wherein the RRC message configures at least one downlink carrier.

Step 504: Receive a dedicated signaling delivered by the network terminal, to acquire information of CP length of the at least one downlink carrier.

Step 506: End.

As can be seen from the above, when utilizing an RRC message to configure CA to a UE, the network terminal delivers information of CP length of all the configured downlink carriers to the UE via a dedicated signaling. Correspondingly, the UE can receive the dedicated signaling, to acquire information of CP length of all the downlink carriers. In such a situation, the UE does not need to detect the synchronization channels of each carrier, and can know CP lengths of all downlink carriers according to the dedicated signaling delivered by the network terminal. As a result, the time required for the UE to acquire information of downlink CP length can be effectively reduced, so as to start the following data transmission more quickly.

Noticeably, downlink CP of each carrier can be normal CP or extended CP. Moreover, in the processes 40 and 50, the dedicated signaling delivered by the network terminal can be an RRC message, e.g. an RRC Connection Reconfiguration message. Furthermore, the same RRC message can be used to configure downlink carriers and also to deliver the corresponding CP lengths. Alternatively, the dedicated signaling can be a Medium Access Control (MAC) control element delivered by the Layer 2 206 for activating the carriers. Compared with the RRC Connection Reconfiguration message, the MAC control element is a signaling delivered by lower layer, and thus can reduce required delivering time. However, whether utilizing the RRC Connection Reconfiguration message or the MAC control element as the dedicated signaling is only one of the viable embodiments of the present invention, which are not limited to these.

In short, by the processes 40 and 50, the network terminal delivers information of CP length of all configured downlink carriers to UE via a dedicated signaling. Therefore, the UE can acquire information of CP length of all downlink carriers according to the dedicated signaling. As a result, the UE does not need to detect the synchronization channels of each carrier, and thus it can reduce the time required for the UE to acquire information of downlink CP length, so as to start the following data transmission more quickly.

In the prior art, after a plurality of carriers are configured to a UE, the UE takes time to detect the synchronization channels of each carrier, and thus it delays the following data transmission. In comparison, in the embodiment of the present invention, after a plurality of carriers are configured to a UE, the UE can know CP length of all downlink carriers without detecting the synchronization channels of the carriers, which significantly reduces the time required for the UE to acquire information of downlink CP length, and thus effectively enhances data transmission efficiency.

To sum up, the present invention can reduce the time required for the UE to acquire information of downlink CP length, so as to effectively enhance data transmission efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling information of cyclic prefix (CP) length in a network terminal of a wireless communication system, the wireless communication system supporting Carrier Aggregation, which enables a user equipment (UE) of the wireless communication system to perform transmission and/or reception through multiple carriers, the method comprising:
configuring at least one downlink carrier to the UE via a Radio Resource Control (RRC) message; and
delivering the information of CP length of the at least one downlink carrier to the UE via a dedicated signaling.

2. The method of claim 1, wherein the downlink CP comprises two types of CP, which are normal CP and extended CP with different lengths.

3. The method of claim 1, wherein the dedicated signaling is the RRC message used to configure the at least one downlink carrier.

4. The method of claim 1, wherein the RRC message is an RRC Connection Reconfiguration message.

5. The method of claim 1, wherein the dedicated signaling is a Medium Access Control control element used to activate the at least one downlink carrier.

6. A communication device for handling information of cyclic prefix (CP) length in a network terminal of a wireless communication system, the wireless communication system supporting Carrier Aggregation, which enables a user equipment (UE) of the wireless communication system to perform transmission and/or reception through multiple carriers, the communication device comprising:
a processor for executing a program; and
a memory coupled to the processor for storing the program; wherein the program comprises:
configuring at least one downlink carrier to the UE via a Radio Resource Control (RRC) message; and
delivering the information of CP length of the at least one downlink carrier to the UE via a dedicated signaling.

7. The communication device of claim 6, wherein the downlink CP comprises two types of CP, which are normal CP and extended CP with different lengths.

8. The communication device of claim 6, wherein the dedicated signaling is the RRC message used to configure the at least one downlink carrier.

9. The communication device of claim 6, wherein the RRC message is an RRC Connection Reconfiguration message.

10. The communication device of claim 6, wherein the dedicated signaling is a Medium Access Control control element used to activate the at least one downlink carrier.

11. A method for handling information of cyclic prefix (CP) length in a user equipment (UE) of a wireless communication system, the wireless communication system supporting Carrier Aggregation, which enables the UE to perform transmission and/or reception through multiple carriers, the method comprising:
receiving a Radio Resource Control (RRC) message delivered by a network terminal of the wireless communication system, the RRC message configuring at least one downlink carrier to the UE; and
receiving a dedicated signaling delivered by the network terminal, to acquire information of CP length of the at least one downlink carrier.

12. The method of claim 11, wherein the downlink CP comprises two types of CP, which are normal CP and extended CP with different lengths.

13. The method of claim 11, wherein the dedicated signaling is the RRC message used to configure the at least one downlink carrier.

14. The method of claim 11, wherein the RRC message is an RRC Connection Reconfiguration message.

15. The method of claim 11, wherein the dedicated signaling is a Medium Access Control control element used to activate the at least one downlink carrier.

16. A communication device for handling information of cyclic prefix (CP) length in a user equipment (UE) of a wireless communication system, the wireless communication system supporting Carrier Aggregation, which enables the UE to perform transmission and/or reception through multiple carriers, the communication device comprising:
a processor for executing a program; and
a memory coupled to the processor for storing the program; wherein the program comprises:
receiving a Radio Resource Control (RRC) message delivered by a network terminal of the wireless communication system, the RRC message configuring at least one downlink carrier to the UE; and
receiving a dedicated signaling delivered by the network terminal, to acquire information of CP length of the at least one downlink carrier.

17. The communication device of claim 16, wherein the downlink CP comprises two types of CP, which are normal CP and extended CP with different lengths.

18. The communication device of claim 16, wherein the dedicated signaling is the RRC message used to configure the at least one downlink carrier.

19. The communication device of claim 16, wherein the RRC message is an RRC Connection Reconfiguration message.

20. The communication device of claim 16, wherein the dedicated signaling is a Medium Access Control control element used to activate the at least one downlink carrier.
